(19) United States
(12) Patent Application Publication
(10) Pub. No.: US 2013/0322663 A1
(43) Pub. Date: Dec. 5, 2013

(54) Transparent Acoustically Active Device

(71) Applicant: Deutsches Zentrum fuer Luft- und Raumfahrt e.V., Koeln (DE)

(72) Inventors: Joerg Melcher, Lehre (Gross Brunsrode) (DE); Jens Guenster, Clausthal-Zellerfeld (DE)

(21) Appl. No.: 13/960,941

(22) Filed: Aug. 7, 2013

Related U.S. Application Data
(63) Continuation of application No. PCT/EP2012/051936, filed on Feb. 6, 2012.

(30) Foreign Application Priority Data
Feb. 7, 2011 (DE) 10 2011 000 528.5

(51) Int. Cl. H04R 17/00

(52) U.S. Cl. CPC H04R 17/00
USPC 381/190

(57) ABSTRACT

The invention relates to an acoustically active device (1) comprising a substrate (2) that is transparent at least in a viewing region, comprising at least one first electrode (3) that lies on the substrate (2), comprising a piezoelectric layer (4) that lies on the at least one first electrode (3), and comprising at least one second electrode (5) that lies on the piezoelectric layer (4). The at least one first electrode (3) and the at least one second electrode (5) are transparent conductive oxide layers, and the piezoelectric layer (4) is made of a transparent piezoelectric material that extends over the entire surface of the viewing region.

### CROSS REFERENCE TO RELATED APPLICATIONS

The present invention is a continuation of international patent application PCT/EP2012/051936 entitled “Transparent Acoustically Active Device”, filed on Feb. 6, 2012 and claiming priority to co-pending German Patent Application No. DE 10 2011 000 528.5 entitled “Transparente akustisch wirksame Vorrichtung” and filed Feb. 7, 2011.

### FIELD OF THE INVENTION

The present invention generally relates to an acoustically active device. More particularly, the present invention relates to an acoustically active device comprising a substrate that is transparent at least in a viewing region, at least one first electrode that lies on the substrate, a piezoelectric layer that lies on the at least one first electrode, and at least one second electrode that lies on the piezoelectric layer.

In a particular embodiment, the present invention relates to noise reduction at windows. An ideal window transmits light but no noise. Passive noise protection by windows, however, has its limits in the range of lower frequencies.

### BACKGROUND ART

Besides passive noise protection systems, active noise protection systems at windows are also known. According to Bauers, R. et al: “Ein Antischallfenster mit Dreifach-verglasung”, proceedings of the DAGA 2005 in Munich, Germany, pages 105-106 (2005) electrodynamic loudspeaker systems are arranged in the area of a frame of a window with triple glazing, i. e. between the glass panels. The resulting sound suppression is indicated as being up to 15 db. However, this known noise protection system results in low thermal insulation values as the area between the middle and the inner glass panel of the triple glazing is no longer hermetically sealed. Further, due to the very high distances between the glass panels, this known noise protection system results in a breakdown of the passive sound reduction by the window in a frequency range above 2,500 Hz.

From “Intelligente Materialien—Neue Fenster gegen Lärm”, n-tv, 11.04.2008, found in the internet via: <URL: http//www.n-tv.detwissen/Neue-Fenster-gegen-Laerm-article261268.html>, an “intelligent” noise protection window is known which has been developed by researchers of Technische Universität Darmstadt (Germany) and Fraunhofer-Institut für Betriebsfestigkeit und Systemzuverlässigkeit (IBF) in the EU-project InMar (Intelligent Materials for Active Noise Reduction). An acceleration sensor measuring vibrations is glued to the window pane. A piezo pad also glued to the window pane generates vibrations which are of opposite phase with regard to those vibrations caused by external sound, and compensates them. The internet article states that the piezo pads have to be made invisible before bringing this “intelligent” noise protection window onto the market.

For active noise reduction, it has also been proposed to provide flat substrates with so-called piezo patches and to set up a mechanical-electrical resonant circuit by means of these piezo patches which operates as a vibration damper for the flat substrates, or to actively operate the piezo patches to excite the substrates for vibrations. The substrates may thus either be used for modifying the impedance properties of the substrate for transmitted sound, or as loudspeaker membranes for generating anti-sound.

One example of the above mentioned piezo patches is the product DuraAct™ available from PI Ceramic GmbH, Lederhose, Germany (www.piceramic.de). The product description “DuraAct™—Piezoelektronische Flächenwandler für Industrie und Forschung” inter alia shows an arrangement of such piezo patches on a transparent tube. The known piezo patches themselves are not transparent.

TCO (Transparent and Conductive Oxide) is the name of oxide materials, particularly made of doped zinc oxide (ZnO) or tin oxide (SnO₂) which are transparent in the visible range but develop electric conductivity. These oxide materials are used at a large scale in the solar industry for making transparent and conductive two-dimensional electric contacts to semi-conductor solar cells. The dopant for enhancing the conductivity of these oxide materials normally consists of boron or fluorine. Layers of oxide materials are deposited on the respective substrates at a large industrial scale by chemical vapor deposition (CVD) or physical vapor deposition (PVD).

For forming films on substrates, sputter techniques are also used. A high-frequency sputter technique for manufacturing a zinc oxide layer with C-axis orientation on a silicone substrate is known from JP 60-124111, for example.

Johnson, R. L.: “Characterization of piezoelectric ZnO thin films and the fabrication of piezoelectric micro-cantilevers”, Master Thesis, submitted to lowe State University (2005) describes the use of a ZnO layer provided with metallic contacts on both sides as a piezoelectric thin film for deforming a cantilever to which these layers are laminated. The piezoelectric activity of a layer made of non-doped ZnO or of ZnO which is insufficiently doped for providing electric conductivity depends on the texture of the layer, its C-axis orientation being advantageous for achieving a maximum piezoelectric effect.

DE 102 96 795 T5 corresponding to US 2002/0190814 A1 discloses a thin film acoustic resonator which comprises a piezoelectric layer between two electrodes. Aluminum nitride or zinc oxide are the preferred piezoelectric materials used here. The electrodes are preferably made of molybdenum.

There still is need for an acoustic effective device by which noise protection at buildings may be basically enhanced without accepting disadvantages.

### SUMMARY OF THE INVENTION

The invention provides an acoustically active device. The device comprises a substrate, which is transparent at least in a two dimensional viewing region, at least one first electrode arranged on the substrate, a piezoelectric layer arranged on the at least one first electrode, and at least one second electrode arranged on the piezoelectric layer. The at least one first electrode and the at least one second electrode are TCO-layers; and the piezoelectric layer is a transparent piezoelectric material which covers the full two dimensional viewing region.

Other features and advantages of the present invention will become apparent to one with skill in the art upon examination of the following drawings and the detailed description. It is intended that all such additional features and advantages be included herein within the scope of the present invention, as defined by the claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. In the drawings, like reference numerals designate corresponding parts throughout the several views.

FIG. 1 shows a section through a device for sound reduction in a first embodiment.

FIG. 2 shows a section through a device for sound reduction in a second embodiment.

FIG. 3 shows a section through a device for sound reduction in a third embodiment.

FIG. 4 shows a section through a border region of a window implementing a device for sound reduction; and

FIG. 5 is a partially sectioned side view of a display implementing a device for sound reduction.

### DETAILED DESCRIPTION

An acoustically active device according to the present invention comprises a substrate that is transparent at least in a viewing region. At least one first electrode is arranged on the substrate. A piezoelectric layer is arranged on the at least one first electrode; and at least one second electrode is arranged on the piezoelectric layer. The at least one first electrode and the at least one second electrode are transparent conductive oxide layers. The piezoelectric layer is made of a transparent piezoelectric material and extends over the entire surface of the transparent viewing region of the substrate. In the acoustically active device according to the present invention, the viewing region will be often delimited by a frame, i.e. the viewing region accounts for the entire visible and transparent area of the substrate enclosed by the frame.

The entire layer construction of the acoustically active device according to the present invention, including the substrate, is transparent in the viewing region, and the layer construction arranged on the substrate is invisible in this viewing region. Here, the term “transparent” means that a transparency is given in the range, i.e. in the wavelength range, of visible light. This transparency, however, allows for a transmission factor which is considerably lower than 1 at all, different or only individual wavelengths of the visible range. Even then, the entire layer construction of the device according to the present invention is regarded as transparent here. The term “invisible” means here that the layer construction which may be used for the generation of sound or anti-sound, does as such not optically appear but at the most provides an optical effect of some coating of the substrate in the viewing region which may also be provided for any optical reason. Thus, the invisibility of the layer construction does not mean that the layer construction is not visible at all. The invisibility of the layer construction is essentially based on the full area coverage of the viewing region of the substrate by the transparent piezoelectric material. Thus, one does not view through adjacent areas of the substrate, one of which being covered with the piezoelectric material and the other of which being uncovered, thus providing an optical contrast. The full area coverage of the substrate by the piezoelectric material does not exclude that the piezoelectric material is not subdivided in separate subareas, as long as theses subareas are not resolved by the human eye. The same applies with regard to the first and second electrodes: The invisibility of the entire layer construction is enhanced, if the at least one first electrode and the at least one second electrode also completely cover the viewing range or even the entire substrate. Nevertheless, a plurality of first electrodes may be provided in such a tight side-by-side arrangement on the substrate that a viewer will not notice any transition between the individual electrodes.

Generally, the entire substrate of the acoustically active device may be transparent, and the piezoelectric material may extend over the entire surface of the entire substrate.

To be able to bring the acoustic activity of the device of the present invention about with small electric energies when activating its electrodes, it is preferred that the substrate with the various layers arranged thereon has a resonance frequency in the acoustic range. It is particularly preferred, if the associated eigenmode of the substrate comprises an antinode in the area of one of the first and/or second electrodes so that the eigenmode may be purposefully activated by means of these electrodes.

Due to the good coating properties and the advantageous mechanical properties of glass, the substrate is preferably made of glass.

The acoustically active device according to the present invention may be implemented in a window pane to use the surface of the window pane for sound reduction, either by integrating a mechanical-electrical converter that is set up by the layer construction in a mechanical electrical resonant circuit acting as a vibration damper, or by operating the mechanic-electrical converter for generating anti-sound, i.e. sound waves which extinguish occurring noise by destructive interference. In this case, the viewing region of the substrate is the area of the window pane delimited by the window frame.

The layer construction of the device according to the present invention is particularly optically inconspicuous, if the respective window pane is anyway to be provided with coatings for purposefully adjusting its transparency. These coatings may completely or at least partially be replaced by the layer construction of the device according to the present invention.

The substrate of the acoustically active device according to the present invention may also be the clear-view screen of a display to form a loudspeaker for providing an acoustic output in addition to the optical output of the display. In this case, the at least one second electrode may be a counter-electrode of a display device, like for example of a luminous or liquid-crystal display. In this case, the at least one second electrode is preferably made of a so-called ITO (indium tin oxide) which is already used in such displays as a material for transparent electrodes.

The first electrode of the device according to the present invention may, for example, be vapor or sputter deposited on the substrate, wherein all vapor and sputter deposition methods known from the prior art may be applied.

Preferably the mechanical-electrical converter constituted by the layer construction of the device according to the present invention is subdivided into partial converters which each only extend over a partial surface of the substrate. The operation of an actively operated mechanical-electrical converter may thus, for example, be adapted to the individual areas of the substrate in an optimum way.

The subdivision of the mechanical-electrical converter into partial converters is preferably made in that a plurality of individually operatable first electrodes are arranged side by side on the substrate. This may particularly be realized in that a first electrode layer which is at first applied as a continuous layer to the substrate is subdivided prior to applying the piezoelectric layer. This subdividing may, for example, be accomplished by locally vaporizing the first electrode layer by means of a laser beam whose wavelength is selected to be selectively absorbed by the first electrode layer. Comparatively small non conductive areas of a width of typically 10 to 100 μm are sufficient for subdividing the continuous first electrode layer into individually activatable first electrodes.

The piezoelectric layer is preferably vapor or sputter deposited onto the at least one or the plurality of first electrodes, wherein again all vapor and sputter deposition methods known from the prior art may be applied, particularly those which have a positive effect on the magnitude of the desired piezoelectric effect of the piezoelectric layer. This particularly means that a texture is adjusted which provides for a high piezoelectric effect in directions parallel to the piezoelectric layer upon activating the electrodes.

Then, the at least one second electrode is applied to the piezoelectric layer, preferably again by vapor or sputter deposition, wherein again all vapor and sputter deposition methods known from the prior art may be applied.

A subdivision of the mechanical-electrical converter constituted by the layer construction of the device according to the present invention into partial converters may also be made in the area of the second electrode in that a plurality of individually operatable second electrodes are formed on the substrate. This may also be accomplished in that a second electrode layer which is at first applied to the piezoelectric layer as a continuous layer is subdivided into the plurality of individually operatable second electrodes. High energy light, particularly a laser beam whose wavelength is selected to be selectively absorbed by the material of the second electrode, may also be used here.

In the device according to the present invention, the layer construction on the substrate may be covered by a continuous transparent cover layer extending over the entire extension of the layer construction including all second electrodes. This cover layer protects the construction of the mechanical-electrical converter, for example while cleaning an active window pane implementing the present invention. The transparent and electrically conductive oxides used for the at least one second electrodes, however, already belong to the group of hard coatings. The cover layer may additionally be provided for purposefully subject the piezoelectric layer of the device according to the present invention to a mechanical pre-stress which is an advantage in operation of the mechanical-electrical converter, particularly with regard to a destruction-free use of the piezoelectric layer. Additionally, the cover layer may also be an optical adjusting layer by which the overall transparency of the layer construction according to the present invention can be adjusted as desired.

The TCO-layers may particularly be made of doped tin oxide or zinc oxide. A particularly suitable transparent piezoelectric material for the piezoelectric layer is un-doped zinc oxide or zinc oxide with a low doping which does not increase its electric conductivity.

All electrodes of the device according to the present invention are preferably electrically contacted in a border region of the substrate which is covered by a frame such that the electric contacts remain invisible.

It may be an advantage with regard to a long lasting function of the device according to the present invention, if a transparent intermediate layer serving as a diffusion barrier is arranged between the at least one first electrode and the piezoelectric layer and/or the at least one second electrode and the piezoelectric layer. In this way, it is avoided that the transparent piezoelectric material of the piezoelectric layer becomes contaminated by diffusion in such a way that its piezoelectric effect is affected.

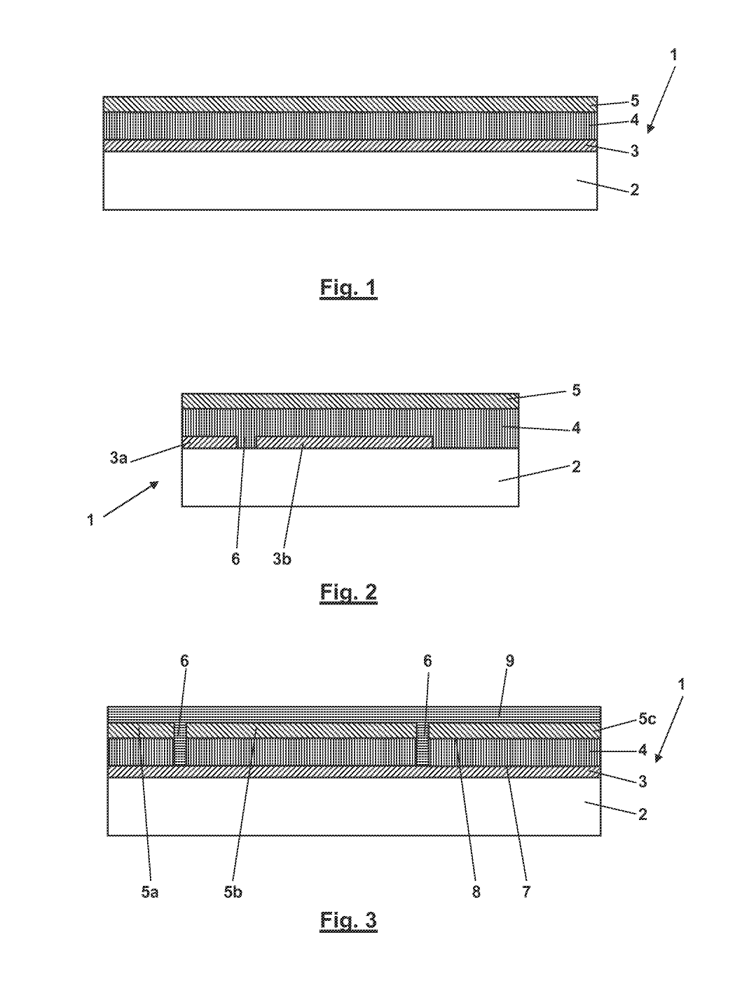

Referring now in greater detail to the drawings, a layer construction of a device 1 for sound reduction shown in FIG. 1 includes a transparent substrate 2, a first electrode 3 arranged on the substrate 2, a piezoelectric layer 4 arranged on the first electrode 3, and a second electrode 5 arranged on the piezoelectric layer 4. The electrodes 3 and 5 and the piezoelectric layer 4 are also transparent. For this purpose, the electrodes 3 and 5 are made of a TCO, like for example tin oxide doped for conductivity, whereas the piezoelectric layer 4 is made of a non-electrically conductive ZnO-layer with C-axis orientation. For example, the thickness of the substrate 2 is about 4 mm here. The thicknesses of the first electrode 3 and the second electrode 5 are each at about 1 μm, and the thickness of the piezoelectric layer 4 is in a range of 0.5 to 100 μm for example. Correspondingly, the depiction of the layer construction in FIG. 1 is not to scale. particularly, the transparent substrate 2 is a window pane made of glass onto which the further layers 3 to 5 have been deposited by a PVD or a CVD or a sputter method. The electrodes 3 and 5 are electrically contacted in a border area of the substrate 2 not depicted here, which—in case of a window pane—is preferably covered by the frame of the respective window such that the contacts to the electrodes 3 to 5 are invisible to somebody viewing the entire window.

The layer construction of the device 1 depicted in FIG. 2 differs from that one in FIG. 1 in that instead of only a single electrode 3 in form of a continuous electrode layer on the substrate 2, a plurality of first electrodes 3a and 3b are provided below the piezoelectric layer 4. The individual first electrodes 3a and 3b are separated by electrically non-conductive areas 6 of a typical width of 10 μm. Thus, the individual first electrodes 3a and 3b can be operated separately from each other. Thus, individual areas of the substrate 2 each belonging to one of the individual first electrodes 3a and 3b may be individually and differently subjected to a mechanical load or deformed by the piezoelectric effect of the piezoelectric layer 4. It does not matter here that the piezoelectric layer 4 protrudes into the free spaces 6 and that only one second electrode is present. Instead, it is advantageous that the second electrode forms a continuous cover layer of the layer construction according to FIG. 2. The areas 6 may be provided in that at first a first electrode layer is applied to the substrate 2 as a continuous layer, and that the first electrode layer is then locally removed by evaporation by means of laser light whose wavelength is adjusted to an absorption band of the material of the first electrode layer.

FIG. 3 shows a layer construction of the device 1 comprising a plurality of second electrodes 5a, 5b and 5c, whereas the first electrode is a continuous first electrode layer. Additionally, the piezoelectric layer 4 is also subdivided here, which, however, only is an option. The electrically non-conductive areas 6, which are provided between the second electrodes 5a, 5b and 5c in lateral direction here, are formed by partially evaporating the material of the second electrodes 5 and the piezoelectric layer 4 of an at first continuous layer construction, like that one of FIG. 1. Additionally, FIG. 3 shows intermediate layers 7 and 8 between the first electrode 3 and the piezoelectric layer 4, and between the piezoelectric layer 4 and the second electrodes 5, respectively, which serve as diffusion barriers between the adjacent layers. It is to be understood that the intermediate layers 7 and 8 of the device 1 are also transparent. A separate cover layer 9 on top of the second electrodes 5 which covers the entire surface of the substrate 2 and which also fills up the areas 6 is also transparent. The cover layer 9 may have the function of an optical adjusting layer for adjusting desired transmission properties of the entire layer construction 1. Additionally or alternatively the cover layer 9 may have the function to purposefully apply a mechanical pre-stress to the piezoelectric layer 4.

FIG. 4 is a section through the border area of a window 10 in which the device 1 according to the present invention is implemented as a window pane 11. The window pane 11 comprises a glass panel 12 as the substrate 2, and the first electrode 3, the piezoelectric layer 4, the second electrode 5 and the cover layer 9 arranged on the glass panel 12. A border area 13 of the window pane 11 is enclosed by a mechanical frame 14. Within the mechanical frame 14 the first electrode 3 and the second electrode 5 are connected to electric lines 15 and 16. This electric connection is covered by the non-transparent frame 14 and thus invisible to anybody viewing through the window 10.

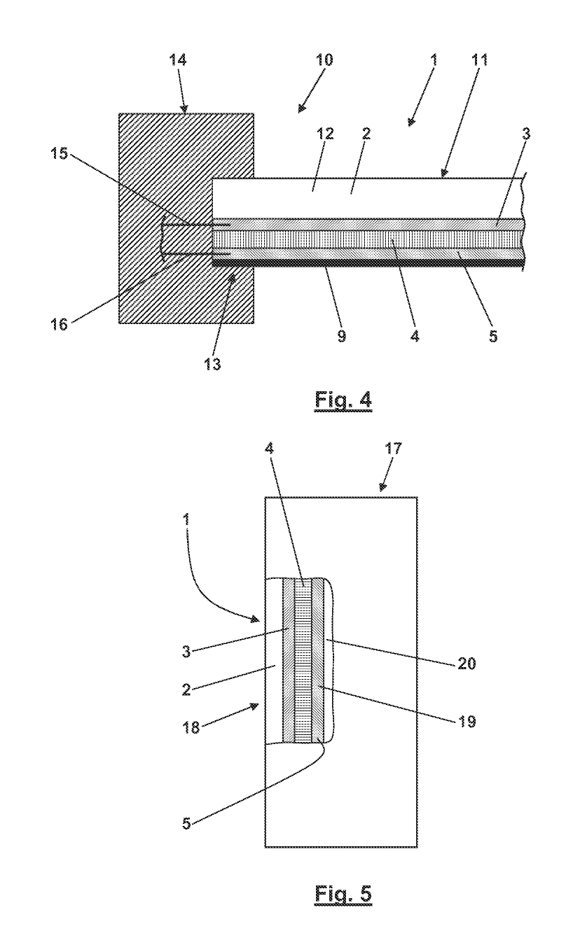

FIG. 5 depicts a display 17 in which the device 1 according to the present invention is implemented as a clear view screen 18. Here, the uncovered main surface of the substrate 2 points outwards. The second electrode 5 at the very back of the device 1 additionally serves as a counter electrode 19 of the display 17. Together with electrodes of the display 17 not depicted here, the counter electrode 19 is used for activating an electroluminescent material 20 in a desired geometric pattern for displaying information. This information may also be acoustically presented by operating the device 1 as a loudspeaker.

Many variations and modifications may be made to the preferred embodiments of the invention without departing substantially from the spirit and principles of the invention. All such modifications and variations are intended to be included herein within the scope of the present invention, as defined by the following claims.

We claim:

1. An acoustically active device comprising:
a substrate, which is transparent at least in a two dimensional viewing region,
at least one first electrode arranged on the substrate,
a piezoelectric layer arranged on the at least one first electrode, and
at least one second electrode arranged on the piezoelectric layer,
wherein the at least one first electrode and the at least one second electrode are TCO-layers, and
wherein the piezoelectric layer is a transparent piezoelectric material which covers the full two dimensional viewing region.

2. The device of claim 1, wherein the two dimensional viewing region is delimited by a mechanical frame.

3. The device of claim 1, wherein at least one of the at least one first electrode and the at least one second electrode also cover the full two dimensional viewing region.

4. The device of claim 1, wherein the substrate together with the at least one first electrode, the piezoelectric layer and the at least one second electrode has a resonance frequency in an acoustic range.

5. The device of claim 1, wherein the substrate is made of glass.

6. The device of claim 1, wherein the substrate is a window pane.

7. The device of claim 1, wherein the substrate is a clear view screen of a display.

8. The device of claim 7, wherein the at least one second electrode is a counter-electrode of the display.

9. The device of claim 8, wherein the at least one second electrode is made of an ITO.

10. The device of claim 1, wherein the at least one first electrode is a vapor or sputter deposited layer.

11. The device of claim 1, wherein a plurality of individually activatable first electrodes is arranged on the substrate.

12. The device of claim 11, wherein the plurality of individually activatable first electrodes are subdivisions of a first electrode layer which has at first been applied to the substrate as a continuous layer.

13. The device of claim 1, wherein the piezoelectric layer is vapor or sputter deposited onto the at least one first electrode.

14. The device of claim 1, wherein the at least one second electrode is a layer vapor or sputter deposited onto the piezoelectric layer.

15. The device of claim 1, wherein the substrate, above the at least one second electrode, is completely covered with a transparent cover layer in the viewing region.

16. The device of claim 5, wherein the cover layer is an optical adjusting layer.

17. The device of claim 15, wherein the cover layer subjects the piezoelectric layer to a mechanical pre-stress.

18. The device of claim 1, wherein the piezoelectric material is undoped zinc oxide.

19. The device of claim 2, wherein all electrodes are electrically contacted to electric lines in a border area of the substrate covered by the mechanical frame.

20. The device of claim 1, wherein transparent intermediate layers are provided as diffusion barriers between the at least one first electrode and the piezoelectric layer and between the at least one second electrode and the piezoelectric layer.
